(19) United States
(12) Patent Application Publication
(10) Pub. No.: US 2002/0181463 A1
(43) Pub. Date: Dec. 5, 2002

(54) System and method for handling asynchronous transfer mode cells

(76) Inventor: Brian James Knight, Cambridge (GB)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/063,377

(22) Filed: Apr. 17, 2002

Related U.S. Application Data
(60) Provisional application No. 60/284,168, filed on Apr. 17, 2001.

(51) Int. Cl. H04L 12/56

(52) U.S. Cl. 370/392; 370/397

(57) ABSTRACT

A system and method for receiving ATM cells is provided. Initially an ATM cell is received by a network element. Next, a hardware filter examines the cell header and determines whether the VPI or VCI (virtual path identifier, virtual channel identifier) extracted therefrom is contained within a hardware lookup table stored within the processor's memory. If it is determined that the received cell's VCI and/or VPI are found within the hardware lookup table, the processor outputs the address of the ‘flow’ data structure associated with the identified values. However, if it is determined that the cell's VPI/VCI are not found in the hardware lookup table, then the cell is passed to a secondary software filter for additional searching. Next, the software filter examines the cell header and identifies the appropriate flow for the VPI/VCI included therein. By limiting the hardware lookup table to be searched by the hardware filter, the system of the present invention significantly reduces the time and resources required to perform this portion of the search. For cell headers outside the range of the hardware lookup table, additional software filtering may be performed to identify the appropriate output flow.

### CROSS REFERENCE TO RELATED APPLICATIONS

This application claims the benefit of U.S. provisional patent application Ser. No. 60/284,168 filed Apr. 17, 2001, the disclosure of which is incorporated herein by reference.

### BACKGROUND OF THE INVENTION

The present invention relates generally to data communication networks and, more particularly, to transmission control mechanisms, including ATM communications processors and switches, and cell reception and header interpretation in asynchronous transfer mode systems/networks.

With the proliferation of the digital age, increasing need has arisen for a single versatile networking technology capable of efficiently transmitting multiple types of information at high speed across different network environments. In response to this need, the International Telegraph and Telephone Consultative Committee (CCITT), and its successor organization, the Telecommunications Standardization Sector of the International Telecommunication Union (ITU-T), developed Asynchronous Transfer Mode, commonly referred to as ATM, as a technology capable of the high speed transfer of voice, video, and data across public and private networks.

ATM utilizes very large-scale integration (VLSI) technology to segment data into individual packets, e.g., B-ISDN calls for packets having a fixed size of 53 bytes or octets. These packets are commonly referred to as cells. Using the B-ISDN 53-byte packet for purposes of illustration, each ATM cell includes a header portion comprising the first 5 bytes and a payload portion comprising the remaining 48 bytes. ATM cells are routed across the various networks by passing though ATM switches, which read addressing information included in the cell header and deliver the cell to the destination referenced therein. Unlike other types of networking protocols, ATM does not rely upon Time Division Multiplexing in order to establish the identification of each cell. That is, rather than identifying cells by their time position in a multiplexed data stream, ATM cells are identified solely based upon information contained within the cell header.

Further, ATM differs from systems based upon conventional network architectures such as Ethernet or Token Ring in that rather than broadcasting data packets on a shared wire for all network members to receive, ATM cells dictate the successive recipient of the cell through information contained within the cell header. That is, a specific routing path through the network, called a virtual path (VP) or virtual circuit (VC), is set up between two end nodes before any data is transmitted. Cells identified with a particular virtual circuit are delivered to only those nodes on that virtual circuit. In this manner, only the destination identified in the cell header receives the transmitted cell.

The cell header includes, among other information, addressing information that essentially describes the source of the cell or where the cell is coming from and its assigned destination. Although ATM evolved from Time Division Multiplexing (TDM) concepts, cells from multiple sources are statistically multiplexed into a single transmission facility. Cells are identified by the contents of their headers rather than by their time position in the multiplexed stream. A single ATM transmission facility may carry hundreds of thousands of ATM cells per second originating from a multiplicity of sources and traveling to a multiplicity of destinations.

The backbone of an ATM network consists of switching devices capable of handling the high-speed ATM cell streams. The switching components of these devices, commonly referred to as the switch fabric, perform the switching function required to implement a virtual circuit by receiving ATM cells from an input port, analyzing the information in the header of the incoming cells in real-time, and routing them to the appropriate destination port. Millions of cells per second need to be switched by a single device.

Importantly, this connection-oriented scheme permits an ATM network to guarantee the minimum amount of bandwidth required by each connection. Such guarantees are made when the connection is set-up. When a connection is requested, an analysis of existing connections is performed to determine if enough total bandwidth remains within the network to service the new connection at its requested capacity. If the necessary bandwidth is not available, the connection is refused.

In order to achieve efficient use of network resources, bandwidth is allocated to established connections under a statistical multiplexing scheme. Therefore, congestion conditions may occasionally occur within the ATM network resulting in cell transmission delay or even cell loss. To ensure that the burden of network congestion is placed upon those connections most able to handle it, ATM offers multiple grades of service. These grades of service support various forms of traffic requiring different levels of cell loss probability, transmission delay, and transmission delay variance, commonly known as delay jitter. It is known, for instance, that many multimedia connections, e.g., video streams, can tolerate relatively large cell losses, but are very sensitive to delay variations from one cell to the next. In contrast, traditional forms of data traffic are more tolerant of large transmission delays and delay variance, but require very low cell losses. This variation in requirements can be exploited to increase network performance.

The design of conventional ATM switching systems involves a compromise between which operations should be performed in hardware and which in software. Generally, but not without exception, hardware gives optimal performance, while software allows greater flexibility and control over scheduling and buffering, and makes it practical to have more sophisticated cell processing (e.g., OAM cell extraction, etc.).

Additional background information pertaining to ATM can be found in a number of sources and need not be repeated directly herein. For example, U.S. Pat. No. 6,122,279 (Milway et al.), assigned to the assignee of the present invention, provides a thorough description of ATM and is incorporated herein by reference. In addition, U.S. Pat. No. 5,953,336 (Moore et al.), also assigned to the assignee of the present invention, provides background on ATM traffic shaping, among other things, and is likewise incorporated herein by reference.

ATM networks transfer data in fixed-size cells consisting of a data payload and a header containing routing and other information. Cells travel between network nodes on point-to-point links. Accordingly, connected nodes are required to make rapid decisions about how to handle each received cell, based on the contents of that cell's header. In some instances a cell may be switched to another port, or may be received locally and reassembled as part of a larger packet. Further, the cell may belong to a virtual circuit or virtual path, or it may be a management cell rather than part of a data stream. Additionally, the format of the cell header may be such that all bits are significant for routing, whereas in other applications, some header fields may carry other information which is ignored during the routing process.

Therefore, there is a need in the art of ATM networking for a more flexible method and system for ATM cell reception.

### SUMMARY OF THE INVENTION

The present invention overcomes the problems noted above, and realizes additional advantages, by providing for a method and system for receiving ATM cells across a computer network. When ATM cells are received from a network they must be distributed to the correct data stream. This involves inspecting the cell header and decoding the virtual path identifier (VPI), virtual circuit identifier (VCI) and payload type. The invention employs a combination of hardware and software to decode the cell header. This combines the speed of hardware lookup with the flexibility of software decoding which can be revised as requirements change. It also allows the full range of VPIs and VCIs to be used if required.

The variety of possible ways of decoding a received cell header suggests that neither a purely hardware nor a purely software solution can adequately cover all situations. A hardware decode can be fast, but is likely to be inflexible, and may require a large amount of memory to support a large number of circuits. A software decode may typically be slower, but it will also be adaptable to more situations. The invention uses a mixture of hardware and software techniques in a novel manner to achieve the advantages of both.

Exemplary objects of this inventive aspect include providing: a new and effective method for interpreting the headers of received ATM cells, combining the speed of hardware interpretation with the flexibility of software interpretation; a method of supporting the full VPI and VCI ranges which is efficient in both memory usage and processing time; a method of extracting OAM cells from active ATM circuits while disregarding OAM cells on inactive ATM circuits; a method of reassembling ATM Adaptation Layer 5 (AAL5) data blocks from ATM cells; a method of maintaining BIP-16 checksums for ATM data streams; and a method of receiving all cells (i.e. all VCIs) on one VPI as a single data stream.

### BRIEF DESCRIPTION OF THE DRAWINGS

The present invention can be understood more completely by reading the following Detailed Description of the Invention, in conjunction with the accompanying drawings, in which:

FIG. 1 is a generalized block diagram illustrating a cell switching system incorporating the present invention;

FIG. 2 is a flow chart illustrating one embodiment of a method for handling ATM cells in accordance with the present invention; and

FIG. 3 is a schematic block diagram illustrating one embodiment of a combination hardware/software ATM cell reception system of the present invention.

### DETAILED DESCRIPTION OF THE PREFERRED EMBODIMENTS

The following description is intended to convey a thorough understanding of the invention by providing a number of specific embodiments and details involving ATM processing and systems. It is understood, however, that the invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

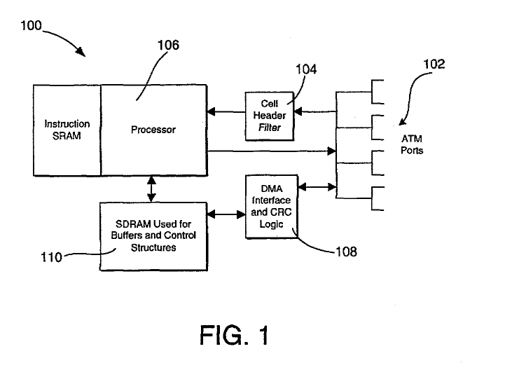

Referring to the Figures and, more particularly to FIG. 1, there is shown a generalized block diagram of an ATM cell switching system 100 incorporating the present invention. In particular, system 100 preferably includes a plurality of ATM ports 102, a filter 104 for interpreting cell headers, a processor 106 having a dedicated static random access memory (SRAM) for storing its instructions, a direct memory access (DMA) interface 108, and hardware for calculating cyclic redundancy codes (CRC).

In operation, the processor 106 selects an input port 102 having thereon a waiting received cell. The cell header filter 104 then inspects the cell header and decodes the VPI/VCI/PTI (PTI—payload type identifier) to determine the appropriate destination circuit, represented here by a data structure called a flow.

Essentially, a flow is a software structure used to hold the state of an ATM virtual path (VP) or virtual circuit (VC). A flow may correspond to the endpoint of the VP or VC (i.e. where the data contained in the cell payload is handled). Alternatively, a flow may correspond to one stage in the decoding of the VPI/VCI in the cell header. Each of these alternative are utilized in the present application and will be described in additional detail below. Typically, a flow consists of state variables and the address of a handler function which handles a received cell on the VP or VC. In this exemplary implementation (which is only one of many possible implementations), a flow is a data structure of at least eight memory words long, with the first eight words arranged as shown below:

[t3]

State variable 1
State variable 2
State variable 3
State variable 4
State variable 5
State variable 6
State variable 7
Handler function
address
Further state
variables

In one implementation, loading eight words from memory into machine registers associated with the processor activates a flow, such that the first seven words are loaded into general-purpose registers, and the eighth is loaded into the processor's Program Counter register, forcing a branch to the associated handler function. It has been determined that this is a very efficient means of invoking a flow: a single machine instruction causes the handler function to be called, with the parameters it needs already loaded into registers.

Returning to FIG. 1, once the cell's destination flow has been determined, processor 106 then reads the cell body from the input port into a buffer 110 attached to the destination flow. The processor 106 then constructs the new (transmission) cell header by rewriting the VPI/VCI and other header fields as appropriate, and storing this header in the buffer 110. Next, the buffered cell (with rewritten header) is transmitted on the appropriate output port 102.

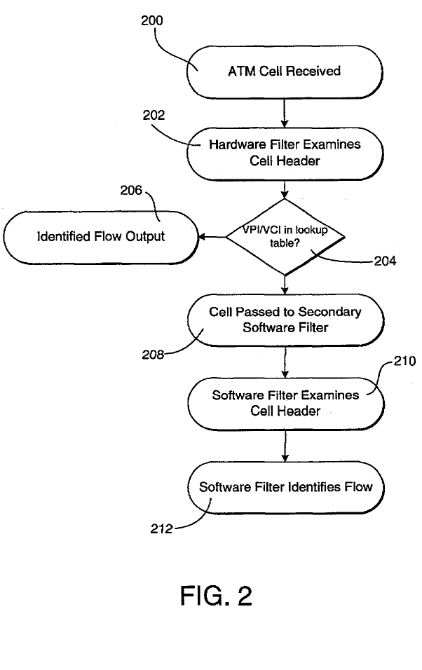

The present application relates specifically to the operation of one embodiment of a cell header filter 104, described briefly above. Referring now to FIG. 2, there is shown a simplified flow diagram illustrating one method for receiving ATM cells in accordance with the present invention. In step 200 an ATM cell is received by a network element incorporating a cell reception processor configured in accordance with the present invention. Examples of such a network element may be a switch, a router, or the like. In step 202, a hardware filter examines the cell header and, in step 204 determines whether the VPI or VCI (virtual path identifier, virtual channel identifier) is contained within a hardware lookup table stored within the processor's memory. In accordance with the present invention, the hardware lookup table is limited in size to a predetermined range of VPIs and VCIs. This size limitation substantially decreases processor search times for VPIs and VCIs which are contained within the table. Additional details regarding the operation and design of the hardware filter are outside the scope of the present invention and will not be described detail herein. Such details may be found in co-pending U.S. application Ser. No. 09/613,098 assigned to the Assignee of the present invention.

If it is determined in step 204 that the received cell's VCI and/or VPI are found within the hardware lookup table, the processor, in step 206, outputs the flow associated with the identified values. However, if it is determined that the cell's VPI/VCI are not found in the hardware lookup table, then the cell is passed to a secondary software filter for additional searching in step 208. In step 210, the software filter examines the cell header and, in step 212, identifies the appropriate flow for the VPI/VCI included therein. By limiting the hardware lookup table to be searched by the hardware filter, the system of the present invention significantly reduces the time and resources required to perform this portion of the search. For cell headers outside the range of the hardware lookup table, additional software filtering may be performed to identify the appropriate output flow. Specific details of this secondary searching methodology will be described in additional detail below.

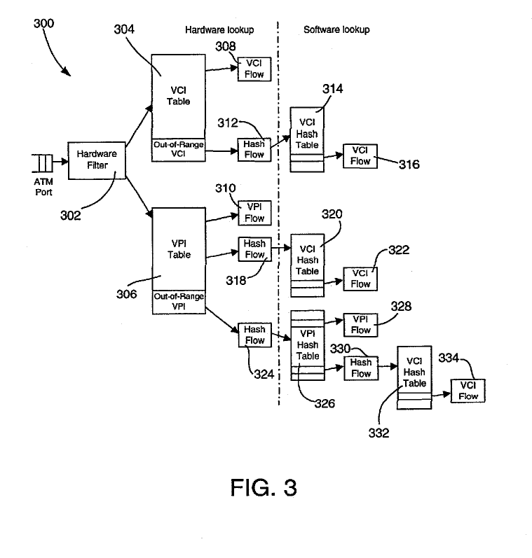

Referring now to FIG. 3, there is shown a more detailed block diagram illustrating one embodiment of a system for filtering ATM cells in accordance with the present invention. As an initial matter, the cell reception system of the invention, referenced generally at 300, utilizes a VPI/VCI lookup function to identify output flows for received cells. An initial hardware filter 302 is utilized to perform the initial lookup of the VPI or VCI contained within the cell's header. The outcome of this lookup may be the memory address of a software “flow” structure, used to hold the state of a particular circuit. In this exemplary embodiment, the hardware lookup yields one of four results, as set forth in the following table:

[t1]

| | | Result |
|---|---|---|
| VPI | VCI | of hardware lookup |
| 0 | 1 ≦ VCI ≦ table size | Flow for VCI |
| 0 | Table size < VCI | Flow for all out-of-range |
| | | VCIs |
| 1 ≦ VPI ≦ table size | n/a | Flow for VPI |
| Table size < VPI | n/a | Flow for all out-of-range |
| | | VPIs |

In particular, the hardware filter 302 first extracts the VCI/VPI from the cell header and conducts a lookup of both a VCI lookup table 304 and a VPI lookup table 306. If it is determined that the cell header contains a VPI of 0 and an in-range VCI, the hardware filter 302 outputs a VCI flow 308 resulting in the forwarding of the cell along the identified VC. Similarly, if it is determined that the cell header contains a non-zero, in-range VPI which is being handled as a complete virtual path, the filter 302 outputs a VPI flow 310 resulting in the forwarding of the cell along the identified VP.

Software filtering only occurs when out-of-range values for either the VCI or the VPI are identified in the cell header. In particular, if the hardware filter determines that the cell includes VPI of 0 and a VCI not included in the VCI table 304, a VCI hash flow 312 is output which results in the software lookup of a VCI hash table 314. As is understood in the art, a hash function is a mathematical function which reduces an input value to a substantially smaller value. Accordingly, a table of hash values may be searched much more quickly than a corresponding table of complete values. By storing hash values for a predetermined range of VCI's (or VPI's), the system of the present invention enables rapid software searching for identifier's whose values are not included in the hardware lookup table. Further, in a hash flow, several of the flow's state variables (described above) are used to hold the address and size of a hash table which is used for the next stage of lookup. In accordance with this understanding, the VCI hash flow 312 hashes the extracted VCI from the ATM cell header. The software filter then looks up the hashed VCI value in a VCI hash table 314. Upon locating the appropriate VCI value in the table 312, the software filter then outputs a VCI flow 316 resulting in the forwarding of the cell along the identified VC.

Similarly, if it is determined during hardware filtering that the cell header includes a non-zero VPI within the range of the hardware lookup table 306 but which also includes a VCI a VCI hash flow 318 is output which includes a hash of the VCI value. The VCI hash value is looked up in a VCI hash table 320 associated with the identified VP. Once the associated VCI flow is identified, the flow 322 is output resulting in the forwarding of the cell along the identified VC. Next, If the hardware filter 302 identifies an out-of-range VPI, a VPI hash flow 324 is output which results in the hashing of the cell's VPI. More specifically, the VPI hash flow 324 results in an interrogation of the ATM port which received the cell to determine which format of VPI is in use. Suitable formats include NNI (Network Network Interface) having 12-bit VPIs, or UNI (User Network Interface) having 8-bit VPIs. After extracting the VPI from the cell header, the VPI hash flow then results in the hashing of the identified VPI. A VPI hash table 326 is then searched by the software filter until the VPI flow associated with the cell's VPI is identified. At this point, it is determined whether the cell includes a VC as well as the identified VP. If not, a VPI flow 328 is generated resulting in the forwarding of the cell along the identified VPI. However, if the cell header also includes a VCI, a VCI hash flow 330 is generated which results in the hashing of the identified VCI value. A VCI hash table 332 associated with the identified VP is then searched by the software filter until the VCI flow 334 associated with the cell's VCI is identified. At this point the identified VCI flow is followed resulting in the forwarding of the cell along the identified VC.

Many forms of hash lookup are well known and fully contemplated by the ATM cell reception method and system of the present invention. The particular form of hash lookup may be selected based on the needs of the particular application and incorporated into the overall VPI/VCI lookup mechanism of the present system.

In a particular VPI or VCI flow, the flow's state variables are used to hold such things as buffer pointers, partial checksums, and statistics. Further, the handler function included within the flow depends on the type of ATM function being performed. For example, the ATM function may be switching cells to another port, may be reassembling the cells into AAL5 (ATM Adaptation Layer 5) blocks, or may be decoding them as AAL2 data. The handler function performs any further decoding of the ATM cell header that is appropriate. The meaning of some cell header fields depends on the VPI and VCI and so they cannot be decoded any earlier in the lookup sequence. For example, it is at this point that F4 and F5 OAM (Operation Administration and Management) cells are identified by inspecting the PTI (Payload Type Indicator) field of the cell header. The handler diverts OAM cells to a special flow instead of handling them itself.

Typical data operations of a handler function are to copy the received cell into a memory buffer, to update any partial checksums (e.g., CRC32, BIP-16), and to update statistics such as the number of cells received on this stream. Following the decoding of the VPI and VCI in the cell header, the VPI/VCI handlers may further implement one or more of the next steps of: reception processing, such as buffering, AAL5 reassembly, CRC checking and BIP-16 maintenance.

As described herein, the ATM cell reception method and system of the present invention may be configured in various ways to provide, for example, one or more of the following: a new and effective system/method for interpreting the headers of received ATM cells, combining the speed of hardware interpretation with the flexibility of software interpretation; a system/method of supporting the full VPI and VCI ranges which is efficient in both memory usage and processing time; a system/method of extracting OAM cells from active ATM circuits while disregarding OAM cells on inactive ATM circuits; a system/method of reassembling AAL5 data blocks from ATM cells; a system/method of maintaining BIP-16 checksums for ATM data streams; and a system/method of receiving all cells (i.e. all VCIs) on one VPI as a single data stream.

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

What is claimed is:

1. A method for handling asynchronous transfer mode cells, comprising the steps of:
receiving an ATM cell having a cell header which includes at least cell destination information;
examining the cell header with a first hardware filter;
determining whether the cell destination information is included within a first hardware lookup table;
identifying a cell flow data structure associated with an entry in the first hardware lookup table associated with the cell destination information if it is determined that the cell destination information is included within the first hardware lookup table; and
performing the following steps if it is determined that the cell destination is not included within the first hardware lookup table:
passing the ATM cell to a second software filter;
examining the cell header with the second software filter; and
identifying the identifying a cell flow associated with an entry in the second software lookup table associated with the cell destination information.

2. The method of claim 1, wherein the first hardware lookup table is limited to a predetermined size.

3. The method of claim 1, wherein the cell destination information includes a virtual path identifier and/or a virtual circuit identifier and wherein the first hardware lookup table includes a first hardware VPI table and a first hardware VCI table.

4. The method of claim 3, wherein the step of passing the ATM cell to a secondary software filter, further comprises the steps of:
hashing the virtual path identifier or virtual channel identifier extracted from the cell header; and
identifying a cell flow data structure associated with an entry in a secondary software hash table associated with the hashed virtual path identifier or virtual channel.

5. The method of claim 3, wherein the step of determining whether the cell destination information is included within a first hardware lookup table further comprises the steps of:
extracting the virtual path identifier and the virtual channel identifier from the cell header;
determining whether the virtual path identifier is zero or non-zero;
performing the following steps if it is determined that the virtual path identifier is zero:
determining whether the virtual channel identifier is included within the first hardware VCI table:
passing the ATM cell to the secondary software filter if it is determined that the virtual channel identifier is not included within the first hardware VCI table; and
identifying a cell flow data structure associated with an entry in the first hardware VCI table associated with the extracted virtual channel identifier if it is determined that the virtual channel identifier is included within the first hardware VCI table;
performing the following steps if it is determined that the virtual path identifier is non-zero:
determining whether the virtual path identifier is included within the first hardware VPI table; and
performing the following steps if it is determined that the virtual path identifier is included within the first hardware VPI table:
determining whether the cell header also includes a virtual channel identifier;
passing the ATM cell to the secondary software filter if it is determined that the cell header also includes a virtual channel identifier; and
identifying a cell flow data structure associated with an entry in the first hardware VPI table associated with the extracted virtual channel identifier if it is determined that a virtual channel identifier is not included within the cell header; and
passing the cell to the secondary software filter if it is determined that the virtual path identifier is not included within the first hardware VPI table.

6. The method of claim 5, wherein the step of passing the ATM cell to the secondary software filter if it is determined that the virtual channel identifier is not included within the first hardware VCI table, further comprises the steps of:
hashing the virtual channel identifier; and
identifying a cell flow data structure associated with an entry in a secondary software VCI hash table.

7. The method of claim 5, wherein the step of passing the ATM cell to the secondary software filter if it is determined that the cell header also includes a virtual channel identifier, further comprises the steps of:
hashing the virtual channel identifier; and
identifying a cell flow data structure associated with an entry in a secondary software VCI hash table associated with the identified virtual path identifier.

8. The method of claim 5, wherein the step of passing the cell to the secondary software filter if it is determined that the virtual path identifier is not included within the first hardware VPI table, further comprises the following steps:
hashing the virtual path identifier; and
identifying an entry in a secondary software VPI has table associated with the hashed virtual path identifier;
determining whether the cell header also includes a virtual channel identifier;
performing the following steps if it is determined that the cell header also includes a virtual channel identifier:
hashing the identified virtual channel identifier;
identifying a cell flow data structure associated with an entry in a secondary software VCI hash table associated with the identified virtual path identifier; and
identifying a cell flow data structure associated with an entry in the secondary software VPI hash table associated with the identified virtual path identifier if it is determined that the cell header does not include a virtual channel identifier.

9. A system for handling asynchronous transfer mode cells, comprising:
means for receiving an ATM cell having a cell header which includes at least cell destination information;
means for examining the cell header with a first hardware filter; means for determining whether the cell destination information is included within a first hardware lookup table;
means for identifying a cell flow data structure associated with an entry in the first hardware lookup table associated with the cell destination information if it is determined that the cell destination information is included within the first hardware lookup table; and
means for performing the following steps if it is determined that the cell destination is not included within the first hardware lookup table:
passing the ATM cell to a second software filter;
examining the cell header with the second software filter; and identifying the identifying a cell flow associated with an entry in the second software lookup table associated with the cell destination information.

10. The system of claim 9, wherein the first hardware lookup table is limited to a predetermined size.

11. The system of claim 9, wherein the cell destination information includes a virtual path identifier and/or a virtual circuit identifier and wherein the first hardware lookup table includes a first hardware VPI table and a first hardware VCI table.

12. The system of claim 11, wherein the means for passing the ATM cell to a secondary software filter, further comprises:
means for hashing the virtual path identifier or virtual channel identifier extracted from the cell header; and
means for identifying a cell flow data structure associated with an entry in a secondary software hash table associated with the hashed virtual path identifier or virtual channel.

13. The system of claim 11, wherein the means for determining whether the cell destination information is included within a first hardware lookup table further comprises the steps of:
means for extracting the virtual path identifier and the virtual channel identifier from the cell header;
means for determining whether the virtual path identifier is zero or non-zero;
means for performing the following steps if it is determined that the virtual path identifier is zero:
determining whether the virtual channel identifier is included within the first hardware VCI table;
passing the ATM cell to the secondary software filter if it is determined that the virtual channel identifier is not included within the first hardware VCI table; and
identifying a cell flow data structure associated with an entry in the first hardware VCI table associated with the extracted virtual channel identifier if it is determined that the virtual channel identifier is included within the first hardware VCI table;
means for performing the following steps if it is determined that the virtual path identifier is non-zero:
determining whether the virtual path identifier is included within the first hardware VPI table; and
means for performing the following steps if it is determined that the virtual path identifier is included within the first hardware VPI table:
determining whether the cell header also includes a virtual channel identifier;
passing the ATM cell to the secondary software filter if it is determined that the cell header also includes a virtual channel identifier; and
identifying a cell flow data structure associated with an entry in the first hardware VPI table associated with the extracted virtual channel identifier if it is determined that a virtual channel identifier is not included within the cell header; and
means for passing the cell to the secondary software filter if it is determined that the virtual path identifier is not included within the first hardware VPI table.

14. The system of claim 13, wherein the means for passing the ATM cell to the secondary software filter if it is determined that the virtual channel identifier is not included within the first hardware VCI table, further comprises:
means for hashing the virtual channel identifier; and
means for identifying a cell flow data structure associated with an entry in a secondary software VCI hash table.

15. The system of claim 13, wherein the means for passing the ATM cell to the secondary software filter if it is determined that the cell header also includes a virtual channel identifier, further comprises:
means for hashing the virtual channel identifier; and
means for identifying a cell flow data structure associated with an entry in a secondary software VCI hash table associated with the identified virtual path identifier.

16. The system of claim 13, wherein the means for passing the cell to the secondary software filter if it is determined that the virtual path identifier is not included within the first hardware VPI table, further comprises:
means for hashing the virtual path identifier; and
means for identifying an entry in a secondary software VPI has table associated with the hashed virtual path identifier;
means for determining whether the cell header also includes a virtual channel identifier;
means for performing the following steps if it is determined that the cell header also includes a virtual channel identifier:
hashing the identified virtual channel identifier;
identifying a cell flow data structure associated with an entry in a secondary software VCI hash table associated with the identified virtual path identifier; and
means for identifying a cell flow data structure associated with an entry in the secondary software VPI hash table associated with the identified virtual path identifier if it is determined that the cell header does not include a virtual channel identifier.

17. A computer readable medium incorporating instructions for handling asynchronous transfer mode cells, the instructions comprising:
one or more instructions for receiving an ATM cell having a cell header which includes at least cell destination information;
one or more instructions for examining the cell header with a first hardware filter;
one or more instructions for determining whether the cell destination information is included within a first hardware lookup table;
one or more instructions for identifying a cell flow data structure associated with an entry in the first hardware lookup table associated with the cell destination information if it is determined that the cell destination information is included within the first hardware lookup table; and
performing the following instructions if it is determined that the cell destination is not included within the first hardware lookup table:
one or more instructions for passing the ATM cell to a second software filter;
one or more instructions for examining the cell header with the second software filter; and
one or more instructions for identifying the identifying a cell flow associated with an entry in the second software lookup table associated with the cell destination information.

18. The computer readable medium of claim 17, wherein the first hardware lookup table is limited to a predetermined size.

19. The computer readable medium of claim 17, wherein the cell destination information includes a virtual path identifier and/or a virtual circuit identifier and wherein the first hardware lookup table includes a first hardware VPI table and a first hardware VCI table.

20. The computer readable medium of claim 19, wherein the one or more instructions for passing the ATM cell to a secondary software filter, further comprises the following instructions:
one or more instructions for hashing the virtual path identifier or virtual channel identifier extracted from the cell header; and
one or more instructions for identifying a cell flow data structure associated with an entry in a secondary software hash table associated with the hashed virtual path identifier or virtual channel.

21. The computer readable medium of claim 19, wherein the one or more instructions for determining whether the cell destination information is included within a first hardware lookup table further comprises the following instructions:
one or more instructions for extracting the virtual path identifier and the virtual channel identifier from the cell header;
one or more instructions for determining whether the virtual path identifier is zero or non-zero;
performing the following instructions if it is determined that the virtual path identifier is zero:
one or more instructions for determining whether the virtual channel identifier is included within the first hardware VCI table;
one or more instructions for passing the ATM cell to the secondary software filter if it is determined that the virtual channel identifier is not included within the first hardware VCI table; and
one or more instructions for identifying a cell flow data structure associated with an entry in the first hardware VCI table associated with the extracted virtual channel identifier if it is determined that the virtual channel identifier is included within the first hardware VCI table;
performing the following instructions if it is determined that the virtual path identifier is non-zero:
one or more instructions for determining whether the virtual path identifier is included within the first hardware VPI table; and
performing the following instructions if it is determined that the virtual path identifier is included within the first hardware VPI table:
one or more instructions for determining whether the cell header also includes a virtual channel identifier;
one or more instructions for passing the ATM cell to the secondary software filter if it is determined that the cell header also includes a virtual channel identifier; and
one or more instructions for identifying a cell flow data structure associated with an entry in the first hardware VPI table associated with the extracted virtual channel identifier if it is determined that a virtual channel identifier is not included within the cell header; and
one or more instructions for passing the cell to the secondary software filter if it is determined that the virtual path identifier is not included within the first hardware VPI table.

22. The computer readable medium of claim 21, wherein the one or more instructions for passing the ATM cell to the secondary software filter if it is determined that the virtual channel identifier is not included within the first hardware VCI table, further comprises the following instructions:
one or more instructions for hashing the virtual channel identifier; and
one or more instructions for identifying a cell flow data structure associated with an entry in a secondary software VCI hash table.

23. The computer readable medium of claim 21, wherein the one or more instructions for passing the ATM cell to the secondary software filter if it is determined that the cell header also includes a virtual channel identifier, further comprises the following instructions:
one or more instructions for hashing the virtual channel identifier; and
one or more instructions for identifying a cell flow data structure associated with an entry in a secondary software VCI hash table associated with the identified virtual path identifier.

24. The computer readable medium of claim 21, wherein the one or more instructions for passing the cell to the secondary software filter if it is determined that the virtual path identifier is not included within the first hardware VPI table, further comprises the following instructions:
one or more instructions for hashing the virtual path identifier; and
one or more instructions for identifying an entry in a secondary software VPI has table associated with the hashed virtual path identifier;
one or more instructions for determining whether the cell header also includes a virtual channel identifier;
performing the following instructions if it is determined that the cell header also includes a virtual channel identifier:
one or more instructions for hashing the identified virtual channel identifier;
one or more instructions for identifying a cell flow data structure associated with an entry in a secondary software VCI hash table associated with the identified virtual path identifier; and
one or more instructions for identifying a cell flow data structure associated with an entry in the secondary software VPI hash table associated with the identified virtual path identifier if it is determined that the cell header does not include a virtual channel identifier.
